(19) United States
(12) Patent Application Publication
(10) Pub. No.: US 2008/0074719 A1
(43) Pub. Date: Mar. 27, 2008

(54) SCANNER PROFILE SETTING APPARATUS FOR SCANNING DISPLAY SYSTEM

(75) Inventor: Kyu Bum Han, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/858,081

(22) Filed: Sep. 19, 2007

(30) Foreign Application Priority Data
Sep. 25, 2006 (KR) 1020060092935

(51) Int. Cl. G02B 26/10

(52) U.S. Cl. 359/198; 345/204

(57) ABSTRACT

Disclosed herein is a scanner profile setting apparatus for a scanning display system. The scanner profile setting apparatus includes a scanner profile setting unit, a scanning control unit, and a scanner drive circuit. The scanner profile setting unit forms a scanner profile for maintaining the linear velocity of an image, projected from the scanner onto a screen, constant.

### CROSS REFERENCE TO RELATED APPLICATION

This application claims the benefit of Korean Patent Application No. 10-2006-0092935, filed on Sep. 25, 2006, entitled “Scanner Profile Setting Apparatus in the Scanning Display System,” which is hereby incorporated by reference in its entirety into this application.

### BACKGROUND OF THE INVENTION

1. Field of the Invention

The present invention relates generally to a scanner profile setting apparatus for a scanning display system.

More particularly, the present invention relates to a scanner profile setting apparatus for a scanning display system, which adjusts the rotational velocity of a scanner so that the linear velocity of an effective image plane is kept constant in a display system using a diffractive optical modulator, thus enabling an image to be uniformly displayed on the effective image plane.

2. Description of the Related Art

Generally, optical signal processing has advantages in that it has high speed characteristics, it is capable of performing parallel processing, and it can process a large volume of information, and research into optical modulators based on spatial light modulation theory is being conducted. Such an optical modulator is used in optical memory, optical display, printer, optical interconnection and hologram fields.

Generally, the prior art display system using a diffractive optical modulator includes a light source system, a condensing unit, an illumination system, a diffractive optical modulator, a Fourier filter system, a projection system, and a screen.

Here, the light source system includes a plurality of light sources. In the application thereof, the plurality of light sources may be configured such that they are sequentially turned on. Furthermore, the condensing unit includes a mirror and a plurality of dichroic mirrors, and allows light from the plurality of light sources to propagate along a single light path through the combination of the light.

The illumination system converts light that has passed through the condensing unit into linear parallel light, and causes the linear parallel light to enter the diffractive optical modulator. The diffractive optical modulator generates linear diffracted light having a plurality of diffraction orders by modulating the incident linear parallel light, and emits linear diffracted light. This diffracted light, having a desired one of the diffraction orders, may be configured such that the light intensity thereof varies depending on the location, so as to form an image on the screen. That is, since the diffracted light generated by the diffractive optical modulator is linear and the intensity of the linear diffracted light may vary depending on the location, it can form a two-dimensional image on the screen when it is scanned across the screen.

The diffracted light produced by the diffractive optical modulator enters the Fourier filter system. The Fourier filter system includes a Fourier lens and a dichroic filter, separates the diffracted light according to diffraction order, and passes only diffracted light having a desired diffraction order therethrough.

The projection system includes a projection lens, a scanner, and an F-theta lens. The projection lens expands incident diffracted light, and the scanner produces an image by projecting incident diffracted light onto the screen, and the F-theta lens causes spot arrangements having regular intervals to be formed on the screen.

The scanner rotates constantly at a predetermined rotational velocity when it is driven. Light reflected from the above-described scanner causes the formation of spot arrangements which are spaced at regular intervals and are scanned onto the screen, and is scanned in such a way that a spot arrangement is formed in a line in the lateral direction of the screen.

The F-theta lens causes the light reflected by the scanner to be scanned on the screen, and maintains a constant distance between the current reflection plane of the scanner and the scanning plane of the screen, so that it maintains the linear scanning velocity on the screen constant, therefore intervals between light spots can be adjusted to be regular. The intervals between the light spots formed on the screen vary according to whether such an F-theta lens exists. Examples thereof are shown in FIGS. 1A and 1B.

FIG. 1A shows the arranged state of spots formed on a screen in the case where an F-theta lens is provided in a prior art display system using a diffractive optical modulator, in which the intervals between the spots are regular.

FIG. 1B shows the arranged state of spots formed on a screen in the case where an F-theta lens is not provided in a prior art display system using a diffractive optical modulator, in which the intervals between the spots are irregular.

However, although, in the prior art display system using a diffractive optical modulator, described above, the F-theta lens is employed to maintain regular intervals between beam spots on the screen, there are problems in that the manufacturing process thereof takes a lot of time and a high cost is required for the display system because there is difficulty in processing and designing the F-theta lens.

### SUMMARY OF THE INVENTION

Accordingly, the present invention has been made keeping in mind the above problems occurring in the prior art, and the present invention is intended to provide a scanner profile setting apparatus for a scanning display system, which adjusts the rotational velocity of a scanner so that the linear velocity of an effective image plane is kept constant in a display system using a diffractive optical modulator, thus enabling an image to be uniformly displayed on the effective image plane.

The present invention provides a scanner profile setting apparatus for a scanning display system, the scanning display system comprising a projection system having a scanner, the scanner profile setting apparatus including a scanner profile setting unit for forming a scanner profile for maintaining the linear velocity of an image, projected from the scanner onto a screen, constant; a scanning control unit for generating scanner control signals according to the scanner profile set by the scanner profile setting unit; and a scanner drive circuit for controlling the scanner in response to the scanner control signals generated by the scanner control unit.

### BRIEF DESCRIPTION OF THE DRAWINGS

The above and other objects, features and advantages of the present invention will be more clearly understood from the following detailed description taken in conjunction with the accompanying drawings, in which:

FIG. 1A is a diagram showing the intervals between spots on a screen in the case where an F-theta lens is provided in a prior art display system using a diffractive optical modulator;

FIG. 1B is a diagram showing the intervals between spots on a screen in the case where an F-theta lens is not provided in a prior art display system using a diffractive optical modulator;

FIG. 2 is a diagram showing the construction of a display system using a diffractive optical modulator to which a scanner profile setting apparatus for a scanning display system according to an embodiment of the present invention is applied;

FIG. 3 is a diagram showing an embodiment of the projection system of FIG. 2;

FIG. 4 is a diagram showing the construction of a display electronic system in which the scanner profile setting apparatus for a scanning display system according to the embodiment of the present invention is provided;

FIG. 5 is a diagram illustrating a process in which a scanner profile setting unit according to the present invention calculates a scanner profile;

FIG. 6 is a graph of h(t) according to the present invention;

FIG. 7 is a conceptual diagram illustrating a process in which the h(t) values of FIG. 6 are applied to Equation 5 according to the present invention;

FIG. 8A is a graph showing a scanner profile depending on time and rotational angle according to the present invention; and

FIG. 8B is a graph showing a scanner profile depending on time and rotational velocity according to the present invention.

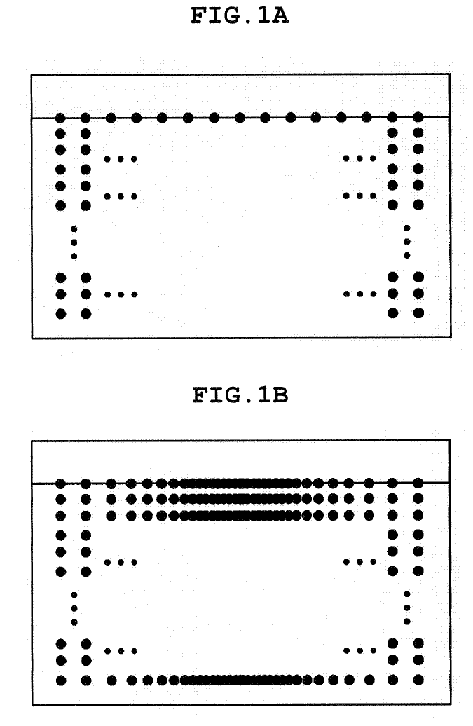

### DESCRIPTION OF THE PREFERRED EMBODIMENTS

A preferred embodiment of the present invention is described in detail below with reference to the accompanying drawings.

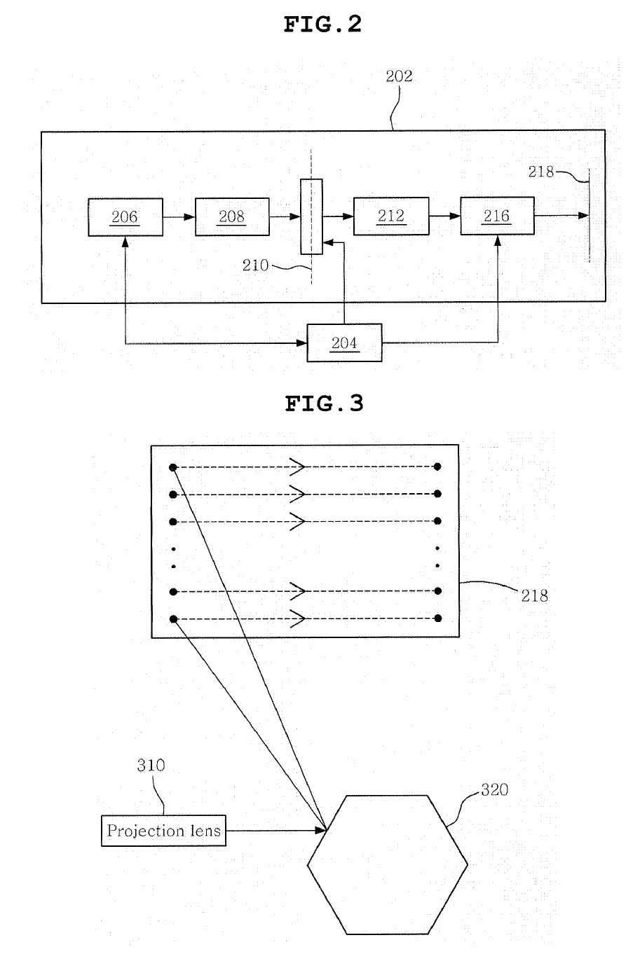

FIG. 2 is a diagram showing the construction of a display system using a diffractive optical modulator to which a scanner profile setting apparatus for a scanning display system according to an embodiment of the present invention is applied.

Referring to FIG. 2, the display system using the diffractive optical modulator to which the scanner profile setting apparatus for a scanning display system according to an embodiment of the present invention is applied includes a display optical system 202 and a display electronic system 204.

The display optical system 202 includes a light source system 206 for generating light and emitting the light. The light source system 206 may employ a light source that is manufactured using a semiconductor element, such as a Vertical External Cavity Surface Emitting Laser (VECSEL), a Vertical Cavity Surface Emitting Laser (VCSEL), a Light Emitting Diode (LED), a Laser Diode (LD) and a Super Luminescent Diode (SL).

The light source system 206 emits laser light. The laser light has a circular cross section, and the intensity profile of the laser light has a Gaussian distribution. For example, the light source system 206 (which actually includes an R laser light source, a G laser light source, and a B laser light source) may be configured to sequentially emit R light, G light and B light.

Furthermore, the display optical system 202 includes an illumination system 208 for radiating the light, emitted from the light source system 206, to the diffractive optical modulator 210 in the form of linear parallel light.

The illumination system 208 converts the laser illumination, which is emitted from the light source system 206, into narrow, long linear light, and subsequently converts the narrow, long linear light into parallel light, and causes the parallel light to enter the diffractive optical modulator 210.

The above-described illumination system 208, for example, may include a convex lens (not shown) or may include a convex lens (not shown) and a collimating lens (not shown).

Furthermore, the display optical system 202 includes a diffractive optical modulator 210 for generating diffracted light, which has a plurality of diffraction orders and the intensity of which is adjusted, by diffracting linear light radiated from the illumination system 208.

Here, the diffracted light, which is emitted from the diffractive optical modulator 210, includes diffracted light having a plurality of diffraction orders, such as 1th-order diffracted light or ±1st-order diffracted light, ±2nd-order diffracted light, ±3rd-order diffracted light and the like. Diffracted light having an odd order and diffracted light having an even order have a phase difference therebetween of 180°.

Furthermore, the diffracted light, which is emitted from the diffractive optical modulator 210, is long, narrow linear diffracted light.

The diffractive optical modulator 210 includes, for example, a plurality of upper reflection units, which can be moved upward and downward and form an array, and a plurality of lower reflection units, which are located between the upper reflection units and are spaced apart from the upper reflection units by a predetermined distance. Furthermore, the diffractive optical modulator 210 may use electrostatic force or electromagnetic force as a driving means for driving the upper reflection units. Furthermore the diffractive optical modulator 210 may use a piezoelectric material layer, on one side of which an upper electrode layer is formed and on the other side of which a lower electrode layer is formed, as a driving means for driving the upper reflection units.

The diffracted light emitted from the above-described diffractive optical modulator 210 may allow diffracted light, formed by a single upper reflection unit and a lower reflection unit paired with the single upper reflection unit, to form diffracted light corresponding to a single pixel of an image formed on a screen 218, and may also allow diffraction light, formed by two or more upper reflection units and two or more lower reflection units, paired with the upper reflection units, to form diffracted light corresponding to a single pixel of an image formed on the screen 218.

The display optical system 202 includes a projection system 212 for performing scanning onto the screen 218 by orienting the diffracted light, which is emitted from the diffractive optical modulator 210 and has a plurality of diffraction orders, toward the screen 218.

When performing scanning onto the screen 218, the projection system 212 maintains the linear velocity of an image, displayed on the screen 218, constant under the control of the display electronic system 204.

An example of the above-described projection system 212 is shown in FIG. 3. The example includes a projection lens 310, and a scanner 320 for causing diffracted light to be oriented toward the screen 218.

The projection lens 310 is constructed from a combination of a plurality of convex lenses and a plurality of concave lenses, and functions to condense incident light so that the focal point of the diffracted light is located on the screen 218.

The scanner 320 may be a galvanometer scanner or a polygon mirror scanner. In the drawing, a polygon mirror scanner is shown as an example. The galvanometer scanner has a rectangular board shape, and a mirror is attached to one surface thereof. The galvanometer scanner rotates around the axis thereof in left and right directions within a predetermined angular range. The polygon mirror scanner has a polygonal column shape, and a mirror is attached to each side surface of a polygonal column. The polygon mirror scanner rotates in a single direction around the axis thereof. The mirror attached to each side surface of the polygonal column changes the reflection angle of incident light using rotation, and thus projects an image onto the screen 218.

Meanwhile, the display optical system 202 is located between the projection system 212 and the screen 218, and includes a filter optical system 216 that passes diffracted light having a desired order among a plurality of beams of diffracted light, which have respective diffraction orders and are projected by the projection system 212, therethrough. As an example of the filter optical system 216, a slit may be used.

Meanwhile, the display electronic system 204 is coupled to the light source system 206, the diffractive optical modulator 210, and the projection system 212. The display electronic system 204 supplies power to the light source system 206. Furthermore, the display electronic system 204 operates the upper reflection unit by providing driving voltage to the upper and lower electrodes of the piezoelectric element of the diffractive optical modulator 210. In this case, the display electronic system 204 performs control so that the projection system 212 maintains the linear velocity of the image, displayed on the screen 218, constant by controlling the projection system 212.

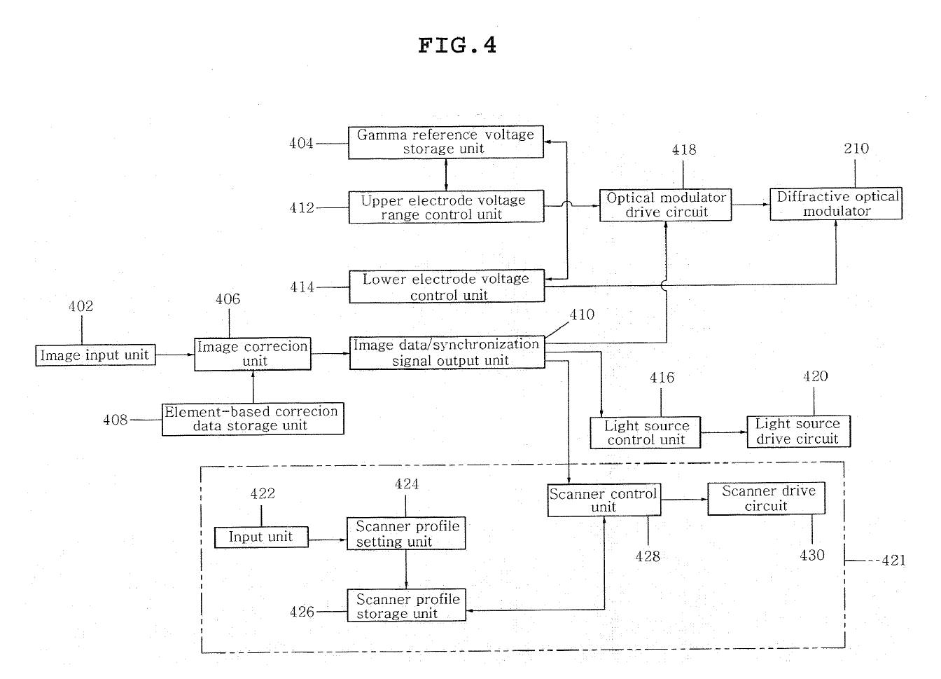

FIG. 4 is a diagram showing the construction of a display electronic system in which the scanner profile setting apparatus for a scanning display system according to the embodiment of the present invention is provided.

As shown in FIG. 4, the display electronic system includes an image input unit 402, a gamma reference voltage storage unit 404, an image correction unit 406, an element-based correction data storage unit 408, an image data/synchronization signal output unit 410, an upper electrode voltage range control unit 412, a lower electrode voltage range control unit 414, a light source control unit 416, an optical modulator drive circuit 418, a light source drive circuit 420, an input unit 422, a scanner profile setting unit 424, a scanner profile storage unit 426, a scanning control unit 428, and a scanner drive circuit 430.

The input unit 422, scanner profile setting unit 424, scanner profile storage unit 426, scanner control unit 428 and the scanner drive circuit 430 constitute a scanner profile setting apparatus 421.

The image input unit 402 receives image data and, at the same time, receives a vertical synchronization signal ‘Vsync’ and a horizontal synchronization signal ‘Hsync.’

The image correction unit 406 converts pieces of image data arranged in a transverse direction into pieces of image data arranged in a longitudinal direction by performing data transposing (or image pivoting) for converting the pieces of image data arranged in the transverse direction into pieces of image data arranged in the longitudinal direction, and outputs the pieces of data arranged in the longitudinal direction. The reason why the image correction unit 406 requires the data to be transposed as described above is because scanning diffracted spot beams, corresponding to a plurality of pixels (for example, 480 pixels when the size of input image data is 480*640), are arranged in a vertical direction and, thus, a scanning beam emitted by the diffractive optical modulator 210 is scanned in a lateral direction.

The image correction unit 406 sequentially outputs the pieces of transposed image data in order from the first column to the last column for a scanning period.

In this case, the image correction unit 406 corrects the image data using an element-based correction data table that is stored in the element-based correction data storage unit 408, and outputs corrected image data to the image data/synchronization signal output unit 410.

Meanwhile, an upper electrode (gamma) reference voltage and a lower electrode (gamma) reference voltage are stored in the gamma reference voltage storage unit 404. Here, the term ‘upper electrode (gamma) reference voltage’ refers to an upper electrode reference voltage that is considered when the optical modulator drive circuit 418 of the diffractive optical modulator 210 outputs a voltage to be applied, depending on the gray levels of pieces of image data for respective elements, and the term ‘lower electrode reference voltage’ refers to a driving voltage that is applied to the lower electrode of the diffractive optical modulator 210.

The reason why it is necessary to store the upper electrode reference voltage and the lower electrode reference voltage in the gamma reference voltage storage unit 404 and to reference them when the optical modulator drive circuit 418 of the diffractive optical modulator 210 outputs the voltage to be applied, depending on a gray level, is because a gamma characteristic in which the intensity of the diffracted light emitted from the diffractive optical modulator 210 varies non-linearly according to the level of applied voltage, rather than varying linearly, is exhibited.

Furthermore, the upper electrode reference voltage and the lower electrode reference voltage, which are stored in the gamma reference voltage storage unit 404, are determined by respective light sources. For example, an R upper electrode reference voltage, ranging from RI to Rn, is determined by an R light source, a G upper electrode reference voltage, ranging from G1 to Gn, is determined by a G light source, and a B upper electrode reference voltage, ranging from B1 to Bn, is determined by a B light source. In this case, the upper electrode reference voltage stored in the gamma reference voltage storage unit 404 may cause the minimum electrode reference voltage and the maximum upper electrode reference voltage to be stored for respective light sources. That is, the upper electrode reference voltage stored in the gamma reference voltage storage unit 404 may cause only the minimum and maximum values thereof to be stored.

In this state, when the gray level of image data is received from the image data/synchronization signal output unit 410, the optical modulator drive circuit 418 acquires an upper electrode voltage matched with the gray level with reference to the upper electrode reference voltage provided through the upper electrode voltage range control unit 412. In this case, the upper electrode voltage range control unit 412 reads the upper electrode reference voltage that is stored in the gamma reference voltage storage unit 404 and outputs the read upper electrode reference voltage to the optical modulator drive circuit 418. At this time, a lower electrode voltage is provided from the lower electrode voltage control unit 414 to the diffractive optical modulator 210. That is, the lower electrode voltage control unit 414 reads the lower electrode reference voltage stored in the gamma reference voltage storage unit 404, and provides the read lower electrode reference voltage to the lower electrode of the diffractive optical modulator 210.

Accordingly, the diffractive optical modulator 210 is driven by the upper electrode voltage provided from the optical modulator drive circuit 418 and the lower electrode voltage provided from the lower electrode voltage control unit 414, and thus forms diffracted light by modulating incident light.

Meanwhile, the correction data for respective elements, which is stored in the element-based correction data storage unit 408, is used for reference so that the image correction unit 406 can correct image data received from the image input unit 402 and generate corrected output image data, and may be given in the form of a table.

Meanwhile, the image data/synchronization signal output unit 410 provides image data, output from the image correction unit 406, to the image data optical modulator drive circuit 418.

Furthermore, the image data/synchronization signal output unit 410 receives the vertical synchronization signal and the horizontal synchronization signal from the image correction unit 406 and outputs them.

The upper electrode voltage range control unit 412 reads the upper electrode reference voltage stored in the gamma reference voltage storage unit 404 and outputs the read upper electrode reference voltage to the optical modulator drive circuit 418.

The lower electrode voltage control unit 414 reads the lower electrode reference voltage stored in the gamma reference voltage storage unit 404 and outputs the read lower electrode reference voltage to the diffractive optical modulator 210.

Meanwhile, when the vertical synchronization signal and the horizontal synchronization signal are received from the image data/synchronization signal output unit 410, the light source control unit 416 controls the light source drive circuit 420 in response to the vertical and horizontal synchronization signals, and causes the light source drive circuit 420 to perform switching on the light sources.

When image data (gray level) is received from the image data/synchronization signal output unit 410, the optical modulator drive circuit 418 generates an upper electrode drive voltage corresponding to the upper electrode reference voltage with reference to the upper electrode reference voltage provided from the upper electrode voltage range control unit 412, and outputs the generated upper electrode drive voltage to the diffractive optical modulator 210.

Meanwhile, the scanner profile setting apparatus 421, as described above, includes an input unit 422, a scanner profile setting unit 424, a scanner profile storage unit 426, a scanning control unit 428, and a scanner drive circuit 430.

The input unit 422 receives basic data that is necessary when the scanner profile setting unit 424 sets a scanner profile. Such basic data includes data about the shortest distance from the scanner 320 to the screen 218 and the like.

The scanner profile setting unit 424 sets a scanner profile with respect to the rotational angle of the scanner 320 using the basic data received from the input unit 422 in order to cause an image, which is being displayed on the screen 218 by the scanner 320, to have a constant linear velocity, and stores the set scanner profile to the scanner profile storage unit 426.

When the vertical synchronization signal and the horizontal synchronization signal are received from the image data/synchronization signal output unit 410, the scanning control unit 428 generates control signals in response to the vertical and horizontal synchronization signals, and provides the control signals to the scanner drive circuit 430. The scanner drive circuit 430 operates the scanner 320 of the projection system 212 in response to the control signals.

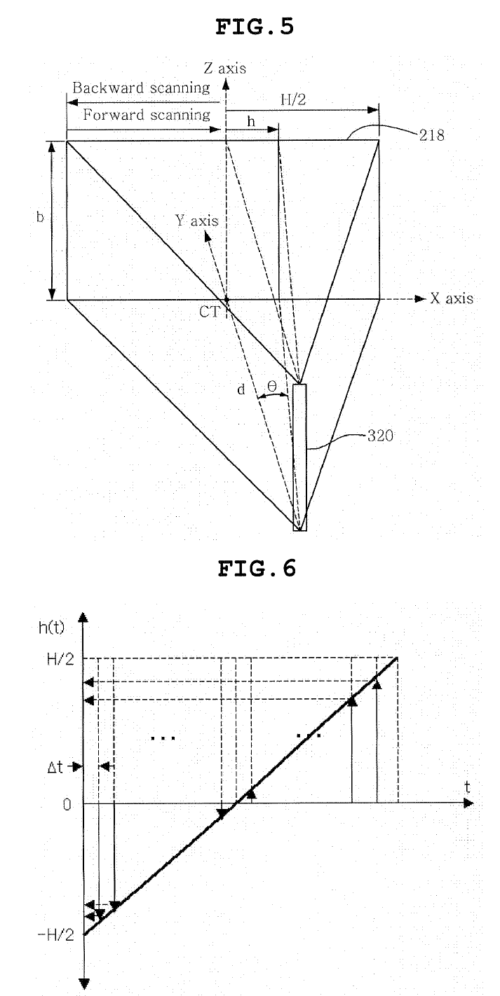

FIG. 5 is an illustrative diagram illustrating a process in which a scanner profile setting unit according to the present invention calculates a scanner profile. The process of calculating a scanner profile is described in detail with reference to FIG. 5 below.

First, the variables given by the following equation are defined as follows.

Referring to FIG. 5, X is a lateral axis that passes through the central axis of the scanner 320. Y is a vertical axis that passes through the central axis of the scanner 320. r is the distance from the central axis of the scanner 320 to the screen 218, and varies with the rotation of the scanner 320. In the case where the central axis of the scanner 320 and the central point CT of the screen 218 are connected by a straight line, θ is the angle formed between the straight line and a straight line formed by moving a spot beam along an X axis. ω is the shortest distance between the scanner 320 and the screen 218. ω is the constant acceleration of the scanner 320. V is the linear velocity of a screen plane. h denotes the moved distance of a screen image with respect to the X axis.

If the linear velocity of the screen plane is defined using the above-described variables, Equation 1 is obtained as follows.

V= ω̅ (1)

From the above equation, a linear velocity constant condition on the screen is expressed by the following Equation 2.

V=r ω̅=c (c is a constant) (2)

If Equation 2 is rearranged with respect to the rotational velocity, Equation 3 is obtained as follows.

ω̅=c/r (3)

If the integral of the above equation is taken, Equation 4 is obtained as follows.

∫ ω̅dt=θ(t)=c∫[1/(d2+h(t)2)½]dt (4)

Accordingly, in the case where the central axis of the scanner and the central point CT of the screen are connected by a straight line, Equation 5 is obtained as follows if the angle formed by the straight line and a straight line formed by moving a spot beam along the x axis is expressed by θ.

θ(t)=c ln|[h(t)+(d2+h(t)2)½]|(ln is a natural logarithm) (5)

Meanwhile, if the distance h that an image displayed on the screen 218 moves with respect to the x axis is expressed as a function, h(t) is obtained. This is expressed by a linear function because a constant linear velocity must be maintained, the graph of which is shown in FIG. 6.

In FIG. 6, h denotes the location of an image displayed on the screen 218 with respect to the x axis. Δ(t) is the duration of a unit pixel in a lateral direction. When total horizontal resolution is N and when the image refresh time is R, this is calculated by Δ(t)=R/N.

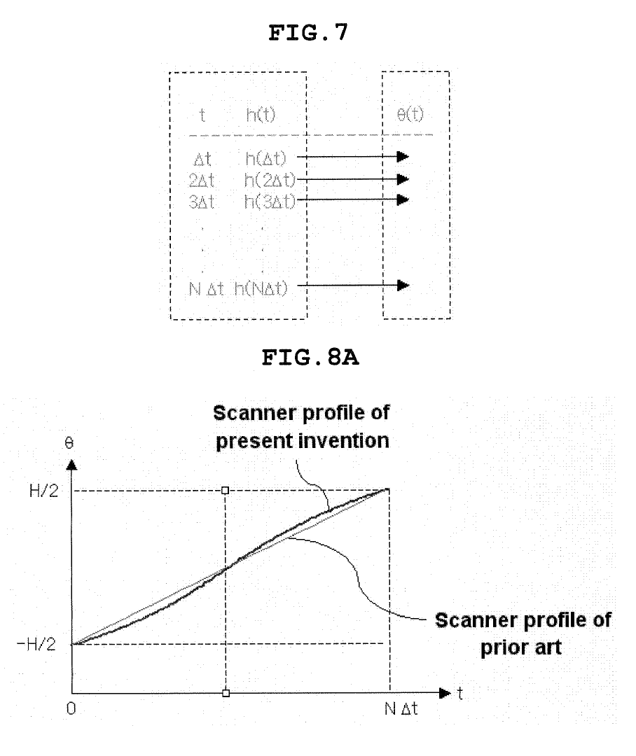

When the value of h(t) is applied to Equation 5, the scanner profile of FIG. 6 can be obtained. FIG. 7 is a conceptual diagram illustrating the substitutive process.

As shown in FIG. 7, when the durations Δ(t) to NΔ(t) are substituted for the time t, the scanner profile can be obtained.

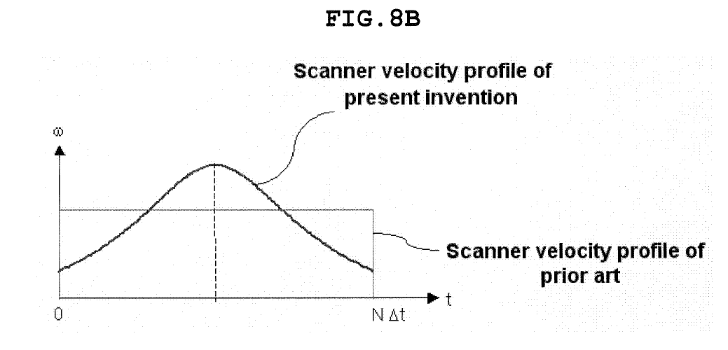

FIG. 8A is obtained when the result is represented with respect to time and rotational angle, and FIG. 8B is obtained when the result is represented with respect to time and rotational angle.

Accordingly, in order to maintain the linear velocity of an image, scanned on the screen 218 by the scanner 320, constant, the rotational velocity and rotational angle of the scanner 32o must have non-linearity, as shown in FIGS. 8A and 8B.

In greater detail, the scanner 320 must be controlled to have a lower rotational angle reference at a front end, prior to the central point thereof, and must be controlled to have a greater rotational angle at a rear end, subsequent to the central point thereof.

The above-described scanner profile set by the scanner profile setting unit 424 is stored in the scanner profile storage unit 426.

Thereafter, when the vertical synchronization signal and the horizontal synchronization signal are received from the image data/synchronization signal output unit 410, the scanning control unit 428 generates scanner control signals in response to the vertical and horizontal synchronization signals, and provides the generated control signals to the scanner drive circuit 430. In this case, the control signals are generated and provided with respect to the scanner profile stored in the scanner profile storage unit 426.

Thereafter, the scanner drive circuit 430 operates the scanner 320 of the projection system 212 in response to the control signals.

As described above, the present invention maintains regular intervals between beam spots by adjusting the rotational angle of the scanner without requiring the use of a high-priced F-theta lens, so that uniform optical energy distribution can be achieved, the manufacturing process can be simplified, and the manufacturing cost can be reduced.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A scanner profile setting apparatus for a scanning display system, the scanning display system comprising a projection system having a scanner, the scanner profile setting apparatus comprising:
a scanner profile setting unit for forming a scanner profile for maintaining linear velocity of an image, projected from the scanner onto a screen, constant;
a scanning control unit for generating scanner control signals according to the scanner profile set by the scanner profile setting unit; and
a scanner drive circuit for controlling the scanner in response to the scanner control signals generated by the scanner control unit.

2. The scanner profile setting apparatus as set forth in claim 1, further comprising a scanner profile storage unit that stores the scanner profile,
wherein the scanner profile setting unit stores the scanner profile in the scanner profile storage unit, and
wherein the scanning control unit generates the scanner control signals according to the scanner profile stored in the scanner profile storage unit.

3. The scanner profile setting apparatus as set forth in claim 1, wherein the scanner profile set by the scanner profile setting unit is a rotational angle profile of the scanner.

4. The scanner profile setting apparatus as set forth in claim 1, wherein the scanner profile set by the scanner profile setting unit is a rotational velocity profile of the scanner.

5. The scanner profile setting apparatus as set forth in claim 1, further comprising an input unit for receiving initial data from an external user and providing the received initial data to the scanner profile setting unit,
wherein the scanner profile setting unit sets the scanner profile according to the initial data received through the input unit.

6. The scanner profile setting apparatus as set forth in claim 1, wherein the scanner profile setting unit sets the linear velocity of the image, projected onto the screen, to a specific value, and then calculates a rotational angle.
